(19) United States
(12) Patent Application Publication
(10) Pub. No.: US 2008/0005331 A1
(43) Pub. Date: Jan. 3, 2008

(54) Information processing device, information processing system, and information processing method

(75) Inventor: Iwao Shiraishi, Atsugi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/641,665

(22) Filed: Dec. 20, 2006

(30) Foreign Application Priority Data
May 25, 2006 (JP) 2006-145210

(51) Int. Cl. G06F 15/173

(52) U.S. Cl. 709/226

(57) ABSTRACT

Disclosed is an information processing device that includes a communication unit which sends first state information that identifies a state of the information processing device itself and receives second state information sent from the external information processing device; and a control unit that generates first list information that identifies an order of information processing device that corresponds to a processing request from external in accordance with the second state information and the first state information, sends the first list information to the external information device listed in the first list information, and receives second list information sent from the external information processing device. The control unit executes processing that corresponds to the processing request by function unit owned by the information processing device itself, in accordance with the order of the information processing device itself set in the first list information or the second list information.

### BACKGROUND OF THE INVENTION

1. Field of the Invention

The present invention relates to an information processing device, an information processing system, and an information processing method.

2. Description of the Related Art

Conventionally, a system that attempts to distribute loads that had been borne on a single information processing device, by connecting a plurality of information processing devices with the same function through a network, has been proposed. For example, a printing system that has a terminal device, a printer server, and a plurality of printers connected through a network has been commercialized. In such printing system, in a case where printing data and an address of one of the printers, to which the printing data is to be outputted, are received from the terminal device by the printer server, the printer server sends the printing data to the printer that is specified by a client. Thus, conventionally, in a case where the printing data cannot be delivered to the printer to which the printing data is to be outputted, the printing data is automatically sent to an alternate printer (For example, refer to Japanese Laid-open Patent Specification No. 2001-56756.).

Concerning the afore-mentioned printing system, the printer server manages delivery destination of the printing data in an integrated manner. Therefore, in a case where disruption occurs at the printer server, printing data cannot be delivered to printer, thus print processing is stagnated. Therefore, without using a printer server, a technique that attempts to keep at least one printer in an immediately printable state and to average use state of printers, by rotating an operation token among a plurality of printers that are connected to a network, has been proposed (For example, refer to Japanese Laid-open Patent Specification No. 2002-318675.).

However, concerning the afore-mentioned technique, in a case where processing capacity of each of the printers are non-uniform, load that is borne on each of the printers are not averaged. Therefore, there is a possibility that efficient operation cannot be conducted.

### SUMMARY

The present invention has been made, concerning an information processing system with a plurality of information processing devices connected, to provide an information processing device, an information processing system, and an information processing method that are able to conduct operation of each information processing device efficiently.

To achieve at least one of the abovementioned objects, an information processing device reflecting one aspect of the present invention comprises: a communication unit to send first state information that identifies a state of the information processing device itself to at least one external information processing device, and to receive second state information that is sent from the at least one external information processing device; and a control unit to generate first list information that identifies an order of information processing devices that corresponds to a processing request from an external device in accordance with the received second state information of the at least one external information processing device and the first state information of the information processing device itself, to send the first list information to the at least one external information device that is listed in the first list information through the communication unit, and to receive second list information that is sent from the at least one external information processing device through the communication unit; wherein the control unit executes processing that corresponds to the processing request by a function unit owned by the information processing device itself, in accordance with the order of the information processing device itself that is set in the first list information or the second list information.

Preferably, the control unit sets an operation flag that specifies a device that corresponds to the processing request, in connection with one information processing device that is listed in the first list information.

Preferably, the control unit determines whether the operation flag that is set in the first list information or in the second list information is in connection with the information processing device itself, and manages the processing request as well as sends third list information with the operation flag set in connection with another information processing device(s) that is in a lower order than the information processing device itself, to the external information processing device(s) that is listed in the third list information through the communication unit, in a case where it is determined that the operation flag is set in connection with the information processing device itself.

Preferably, the control unit determines whether the information processing device itself is set to the highest order in accordance with the received second list information, and in a case where it is determined that the information processing device itself is set to the highest order, sets a master flag, that shows whether the information processing device itself is a distribution source of any one of the first list information, the second list information, and the third list information, to master state.

Preferably, the control unit sends state information request information that requests the second state information to the at least one external information processing devices through the communication unit, in a case where it is determined that the information processing device itself is set to the highest order and the master flag is set to the master state.

Preferably, the control unit sends the first state information of the information processing device itself to the at least one external information processing device through the communication unit, in a case where the control unit receives the state information request information through the communication unit.

Preferably, the control unit generates the first state information in accordance with process capacity and/or process state of the information processing device itself.

Preferably, the control unit determines whether to send or not to send the first state information to the at least one external information processing device, in accordance with the state of the information processing device itself.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 shows a structure of a print processing system;

FIG. 2 is a block diagram of MFP that structures a printing system;

FIG. 3 shows one example of condition table stored in memory unit of the MFP;

FIG. 4 is a ladder chart showing a procedure of list type token generation processing;

FIG. 5 is a view to explain performance of master MFP and slave MFP when list type token generation processing is executed;

FIG. 6 shows one example of list type token;

FIG. 7 is a flowchart showing a procedure of list type token receiving processing;

FIG. 8 is a flowchart showing a procedure of job response processing;

FIG. 9 is a view to explain a state of MFP 2 when list type token receiving processing is executed;

FIG. 10A shows a state of operation flag when the list type token receiving processing of FIG. 9 is executed, which is a list type token updated by the MFP 2C;

FIG. 10B shows a state of operation flag when the list type token receiving processing of FIG. 9 is executed, which is a list type token updated by the MFP 2F; and

FIG. 10C shows a state of operation flag when the list type token receiving processing of FIG. 9 is executed, which is a list type token updated by the MFP 2B.

### DETAILED DESCRIPTION OF THE PREFERRED EMBODIMENTS

An embodiment of the present invention will be described hereinafter with reference to figures. However, scope of the present invention is not limited to the examples shown in figures.

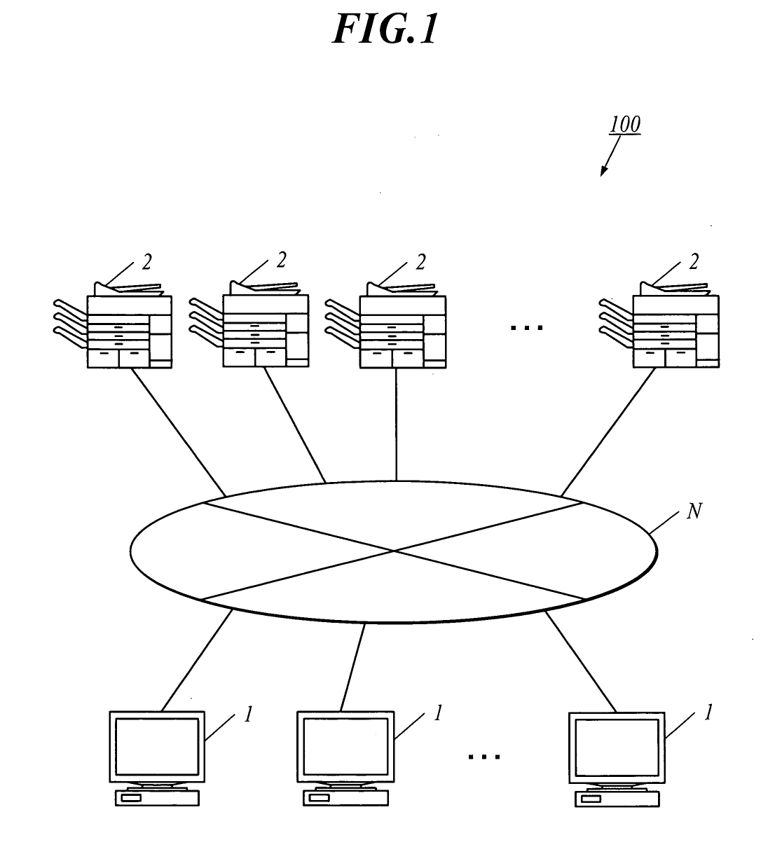

First of all, structure of print processing system 100 according to the present embodiment will be described with reference to FIG. 1.

As shown in FIG. 1, the print processing system 100 includes a plurality of terminal devices 1, and a plurality of Multi Function Printers (MFP) 2 (MFP 2A through MFP 2F), and each of the devices are connected so that they can communicate with each other through a network N. Here, the number of devices of each kind that structure the print processing system 100 is not limited to the example given in figure.

The terminal device 1 is an information processing terminal such as Personal Computer (PC) and the like, and is able to conduct broadcasting of processing request information that relates to a predetermined processing, to the network N. In addition, in a case where response information is received from the MFP 2 that corresponds to the processing request information, the terminal device 1 sends job data, which is the entity of processing, to this MFP 2. Thus the MFP 2 executes the predetermined processing. Here, the predetermined processing means a processing that corresponds to a function of the MFP 2. For example, image reading processing by an image reading unit 24, print processing by an image forming unit 26, FAX sending processing by a communication unit 27, and the like can be mentioned. Here, in the present embodiment, processing request information and job data sent from the terminal device 1 are related to print processing.

The MFP 2 as the information processing device is a device that has a plurality of functions such as printer, scanner, and the like. The MFP 2 receives print job data sent from the terminal device 1, and conducts print processing that corresponds to the print job data.

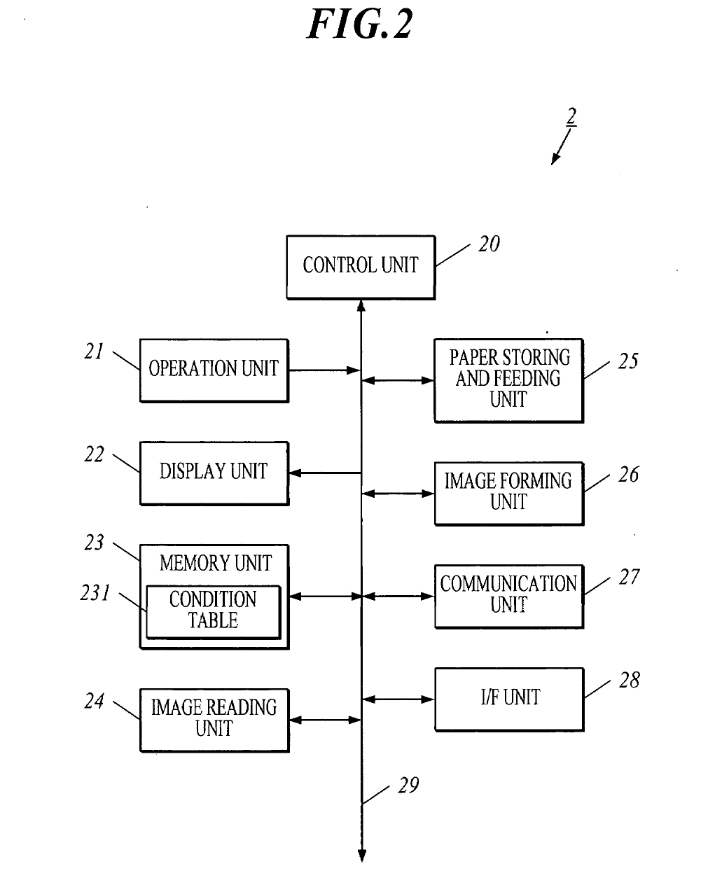

FIG. 2 shows an internal structure of the MFP 2. As shown in FIG. 2, MFP 2 is structured provided with a control unit 20, an operation unit 21, a display unit 22, a memory unit 23, an image reading unit 24, a paper storing and feeding unit 25, an image forming unit 26, a communication unit 27, an I/F unit 28, and the like. Each unit is connected through a bus 29.

The control unit 20 comprises a Central Processing Unit (CPU) not shown, a Read Only Memory (ROM), a Random Access Memory (RAM), and the like. The CPU executes various kinds of processing described later, such as list type token generation processing, list type token receiving processing, and the like, by collaboration with various kinds of control programs that are stored in the memory unit 32 beforehand, and by using a predetermined region of the RAM as work area. Thus the CPU controls performance of each unit that structures the MFP in an integral manner.

The operation unit 21 is provided with an input key and the like, receives information that is inputted by a user as an input signal, and outputs the input signal to the control unit 20. The display unit 22 is structured with Liquid Crystal Display (LCD) and the like, and displays various kinds of information in accordance with a display signal from the control unit 20. In addition, the display unit 22 may structure a touch panel combined with the operation unit 21.

The memory unit 23 comprises a non-volatile storage medium that is structured with a magnetic or an optical recording medium, or a semiconductor memory, and stores programs required to perform the MFP 2, and data related to execution of the program.

The memory unit 23 also stores job data sent from the terminal device 1 through the network N, image data of document that was read by the image reading unit 24, list type token described later that was generated by the information processing device itself, list type token sent from other MFP 2, and the like, under the control of the control unit 20.

Further, the memory unit 23 stores master flag, which shows whether the MFP 2 itself is a master MFP which becomes a distribution source of list type token described later, and the master flag is set to “ON” or “OFF” under the control of the control unit 20. Hereinafter, MFP 2 that has its master flag “ON” is referred to as master MFP, and MFP 2 that has its master flag “OFF” is referred to as slave MFP.

The memory unit 23 stores a condition table 231 to indicate a state of MFP 2 itself. Here, in the condition table 231, condition to calculate an evaluation value from specifications and functions provided to MFP 2 itself, load rate of each functional unit, and the like, is defined.

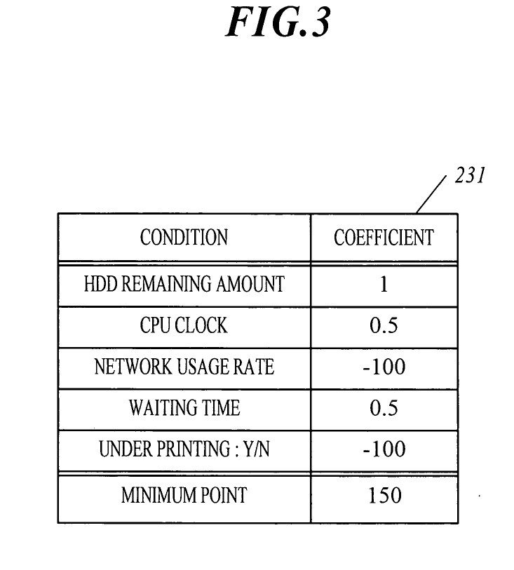

FIG. 3 shows one example of the condition table 231. As shown in FIG. 3, in the condition table 231, “HDD remaining amount” and “CPU clock” are defined as a condition that relates to processing capacity of the MFP 2, and represents remaining amount of the memory unit 23 and clock frequency of the CPU of the control unit 20, respectively. To each of these conditions, coefficient “1” and “0.5” are defined respectively in correspondence, and the value identified by this coefficient is multiplied with the values of “HDD remaining amount” and the “CPU clock” to obtain point, under control of the control unit 20. For example, in a case where the “HDD remaining amount” is 500 MB, point is 500×1=500, and in a case where the “CPU clock” is 2 GHz, point is 2000×0.5=1000.

In addition, in the condition table 231, “network usage rate”, “waiting time”, and “under printing” are defined as a condition that relates to processing state of the MFP 2, and represents usage rate of the communication unit 27, waiting time of MFP 2 itself, and whether the image forming unit 26 is under usage or not, respectively. To each of these conditions, coefficient “−100”, “0.5”, and “−100” are defined respectively in correspondence, and the value identified by this coefficient is multiplied with the values of “network usage rate”, “waiting time”, and a value that corresponds to the state of “under printing” to obtain point, under control of the control unit 20. For example, in a case where the “network usage rate” is 10%, point is 10×−100=−1000, and in a case where the “waiting time” is 30 minutes, point is 30×0.5=15. Concerning “under printing”, “1” or “0” is set corresponding to whether it is conducting printing or not, and in a case where it is conducting printing, point is 1×−100=−100.

Further, in the condition table 231, a “minimum point” to determine whether MFP 2 itself is in a state in which the MFP 2 is able to conduct processing of the print job or not, is defined. By comparing the “minimum point” and the total value of each point that was calculated from the afore-mentioned conditions (hereinafter referred to as “state point”) under the control of the control unit 20, it is determined whether MFP 2 itself is in a state in which the MFP 2 is able to conduct processing of the print job or not. For example, in the afore-mentioned example, state point is 415 (i.e., 500+1000−1000+15−100=415), and thus exceeds the “minimum point” of 150. Therefore, it is determined that it is in a state in which the MFP 2 is able to conduct processing of the print job. Further, in a case where it is determined that it is in a state in which the MFP 2 is able to conduct processing of the print job, the control unit 20 sends the total value of each point as a state information of MFP 2 itself to other MFP 2, through the communication unit 27.

Here, in the afore-mentioned condition table 231, various kinds of conditions and coefficients that correspond to print processing request (pull print) from the terminal device 1 are defined. However, various kinds of conditions and coefficients set to the condition table 231 are not limited to the afore-mentioned example. It may also store condition table that corresponds to image reading processing, facsimile sending processing, and the like. Here, in such a case, concerning a list type token generation processing described later, list type token is generated for each function such as image reading processing, facsimile sending processing, and the like. Then, this list type token is sent (distributed) to each MFP 2 that is included in the list type token.

The image reading unit 24 includes a light source to irradiate light on a document, image sensors such as a Charge Coupled Device (CCD) image sensor to conduct photoelectric conversion of reflected light from the document, Complementary Metal-Oxide Semiconductor (CMOS) image sensor, and the like, scanning unit to scan light irradiated to the document, an image processing unit to apply various kinds of conversions and processing to electric signal that is read by the image sensor and to output image data, and the like (none of them shown). The control unit 20 controls the image reading unit 24 in accordance with the processing request information (job data) that relates to reading an image sent from the terminal device 1, and thus executes image reading processing to read an image recorded on a document.

The paper storing and feeding unit 25 includes a paper storing unit to store recording paper, a paper availability detecting unit to detect whether paper is stored in the paper storing unit or not, a size detecting unit to detect paper size of the recording paper stored in the paper storing unit, a feeding unit to feed the recording paper stored in the paper storing unit, and the like (none of them shown). Under the control of the control unit 20, the paper storing and feeding unit 25 feeds a recording paper with paper size which corresponds to the image data or is instructed through the operation unit 21, to an image forming position of the image forming unit 26, and then ejects the recording paper after image forming.

The image forming unit 26 is a printer of ink jet type, laser type, thermal transfer type, dot impact type, and the like. The image forming unit 26 forms image on the recording paper in accordance with image data inputted from the control unit 20. The control unit 20 controls the image forming unit 26 in accordance with the processing request information (job data) that relates to printing, sent from the terminal device 1, and thus executes print processing to record image on the recording paper.

The communication unit 27 is provided with a communication interface such as network interface card and the like, and conducts communication control of various kinds of information that are sent and received among other devices connected to the network N. In addition, the communication unit 27 is provided with a facsimile modem and the like, and conducts facsimile communication. The control unit 20 controls the communication unit 27 in accordance with the processing request information (job data) that relates to sending facsimile, sent from the terminal device 1, and thus executes facsimile sending processing to send facsimile.

The I/F unit 28 is a communication interface that conducts data communication with other device, and is structured with Universal Serial Bus (USB), IEEE 1284, IEEE 1394, PCMCIA, and the like.

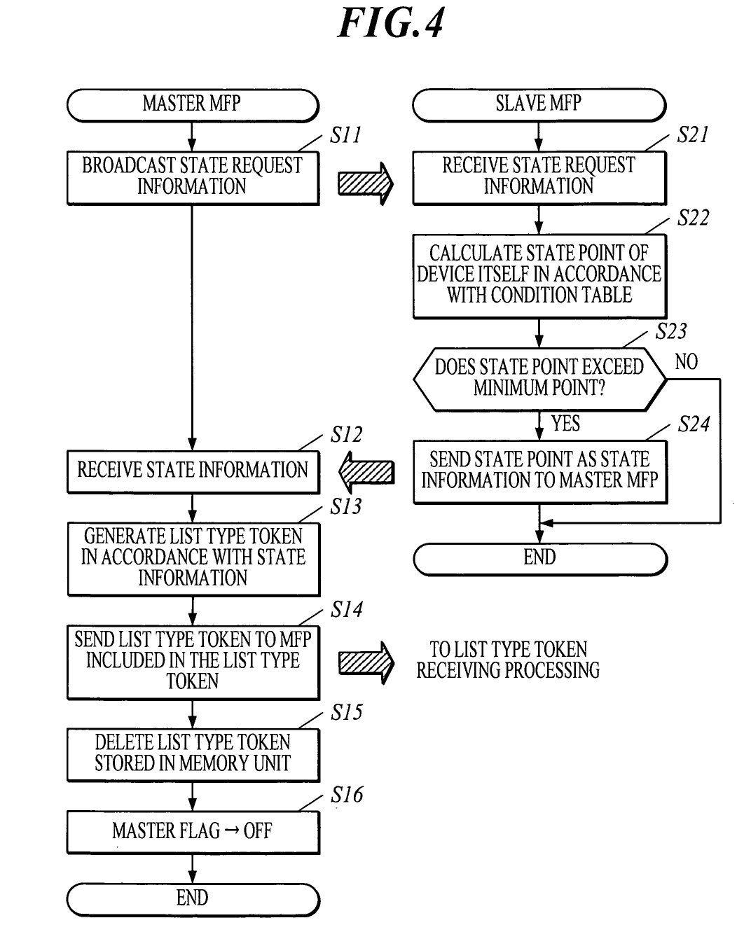

Hereinafter, performance of the MFP 2 will be described with reference to FIG. 4.

FIG. 4 shows a procedure of processing that relates to generation of list type token (hereinafter referred to as list type token generation processing). Here, among the processing of FIG. 4, steps S11 through S16 identify processing that is executed by collaboration of the control unit 20 of MFP 2 that generates list type token (hereinafter referred to as master MFP), with a predetermined program stored in the memory unit 23. Steps S21 through S24 identify processing that is executed by collaboration of control unit 20 of MFP 2 other than the master MFP (hereinafter referred to as slave MFP), with the predetermined program stored in the memory unit 23.

First of all, the control unit 20 of the master MFP conducts broadcasting of state request information that require obtainment of state information, to slave MFP that is connected to print processing system 100 (step S11).

Meantime, in a case where the control unit 20 of the slave MFP receives the state request information sent from the master MFP (step S21), the control unit 20 of the slave MFP calculates state of device itself as a state point (step S22), in accordance with the condition table 231 stored in the memory unit 23. Then, it is determined whether it is in a state in which the slave MFP is able to conduct processing of the print job or not (step S23), by comparing the state point and the minimum point of the condition table 231.

In a case where it is determined in step S23 that the state point exceeds the minimum point (step S23; Yes), this state point is sent as state information to the master MFP, which is the sending source of the state request information (step S24), and the processing at the slave MFP side is concluded.

In addition, in a case where it is determined in step S23 that the state point is below the minimum point (step S23; No), the processing at the slave MFP side is concluded immediately.

On the other hand, in a case where the control unit 20 of the master MFP receives the state information sent from the salve MFP (step S12), the control unit 20 of the master MFP sorts the name of slave MFP, which is the sending source of the state information, in accordance with the value identified by the state information (state point). Subsequently, list of slave MFP after sorting is expressed in a list form, and generates list type token (list information) that has an operation flag recorded in connection with the slave MFP in highest order (step S13).

Here, the order of each MFP that are set in the list type token represents the order of information processing device that corresponds to the processing request from the terminal device 1, and it is preferable that MFP with higher state point is set to higher order. In this embodiment, all of the slave MFP that responded state information were included in the list type token. However, the embodiment is not limited to this given embodiment, and the slave MFP with the lowest state point, that is, the slave MFP in the lowest sort order, may be eliminated from the list type token.

Next, the control unit 20 of the master MFP sends (distributes) the generated list type token to each slave MFP that is included in the list type token (step S14). Further, in a case where a former list type token is stored in the memory unit 23, this former list type token is first deleted (step S15), and then the master flag is set to “OFF” (step S16), and the present processing is concluded.

Here, in the present embodiment, the master MFP is assigned to the MFP 2 in the highest order, that is, the MFP 2 with the highest state point, among the MFP 2 that are included in the list type token. However, it is not limited to the given embodiment, and the MFP 2 in the lowest order, that is, the MFP 2 with the lowest state point, may be assigned. Further, role as the master MFP may be assigned in rotation. Concerning a case where list type token is not yet generated, such as a case of initial operation of the print processing system 100 or the like, a predetermined MFP 2 may be assigned as the master MFP, or state point of each MFP 2 may be exchanged with each other and the MFP 2 with the highest state point may be assigned as the master MFP.

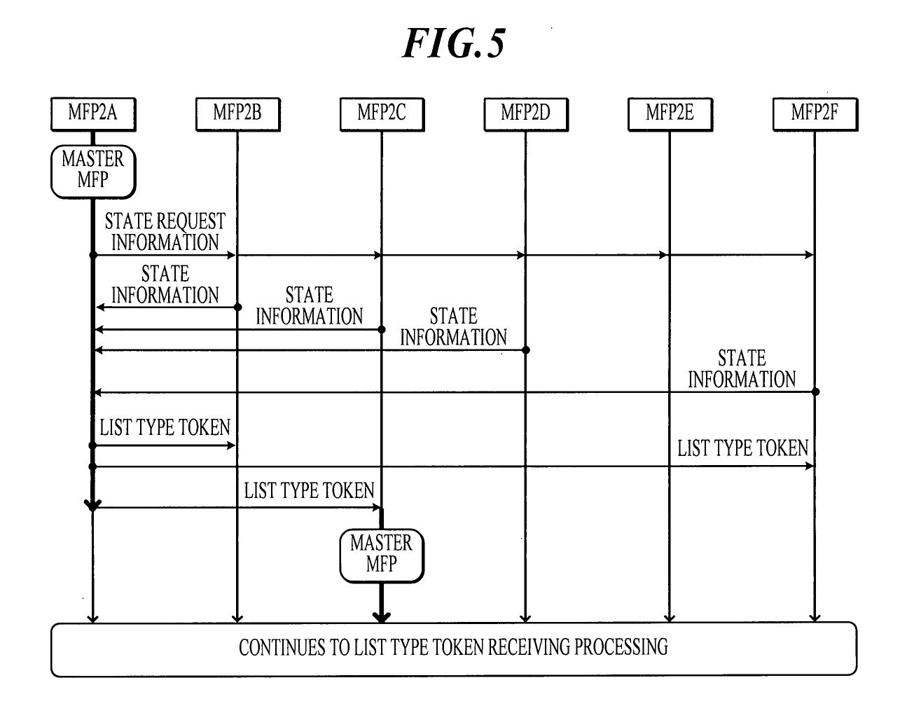

FIG. 5 is a view to explain performance of master MFP and slave MFP during execution of the afore-mentioned list type token generation processing. Here, an example of performance in which six MFP 2 (MFP 2A through MFP 2F) are connected to the network N, and the MFP 2A is the master MFP is given.

First of all, state request information is broadcasted from the MFP 2A which is the master MFP, to the slave MFP (MFP 2B through MFP 2F).

Subsequently, the slave MFP that received the state request information determines whether it is in a state in which the slave MFP that received the state request information is able to conduct processing of the print job or not, in accordance with the state point of device itself. In a case where it is determined that it is in a state in which the slave MFP that received the state request information is able to conduct processing, the state point is sent to the MFP 2A as the state information. Here, concerning the MFP 2E among the slave MFP, it is determined that it is not in a state in which the MFP 2E is able to conduct processing, and state information is not sent from the MFP 2E.

Next, when the MFP 2A receives the state information sent from the slave MFP (MFP 2B, MFP 2C, MFP 2D, and MFP 2F), it sorts the name of slave MFP, which is the sending source of the state information, in accordance with the state point identified by these state information. Subsequently, list of slave MFP after sorting is expressed in a list form, and generates list type token that has an operation flag set in connection with the slave MFP in highest order.

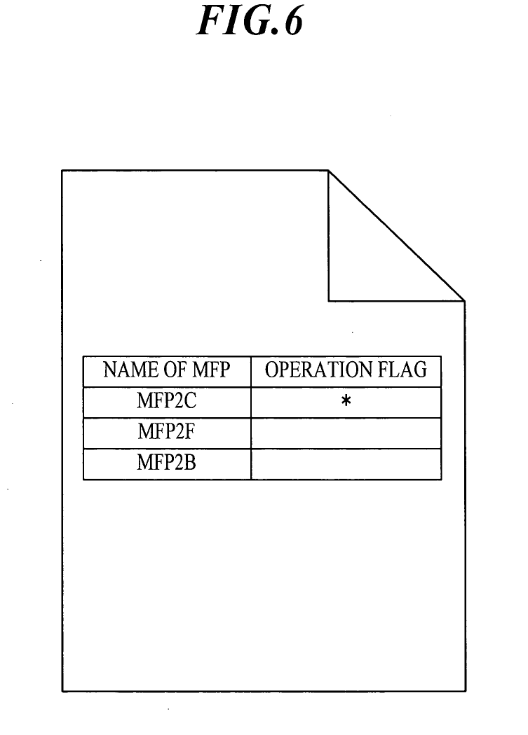

FIG. 6 shows an example of generated list type token. Here, the value of state information (state point) sent from the slave MFP decreases in the order of MFP 2C, MFP 2F, MFP 2B, MFP 2D, and a list type token, in a case where the MFP 2D with minimum value is eliminated, is shown. MFP 2C with the maximum state point is set with the operation flag (*) in connection.

Subsequently, the MFP 2A distributes the list type token to the MFP 2B, MFP 2C, and MFP 2F that are included in the generated list type token, and then concludes the present processing. Then, standby is conducted until state request information is received from other MFP 2.

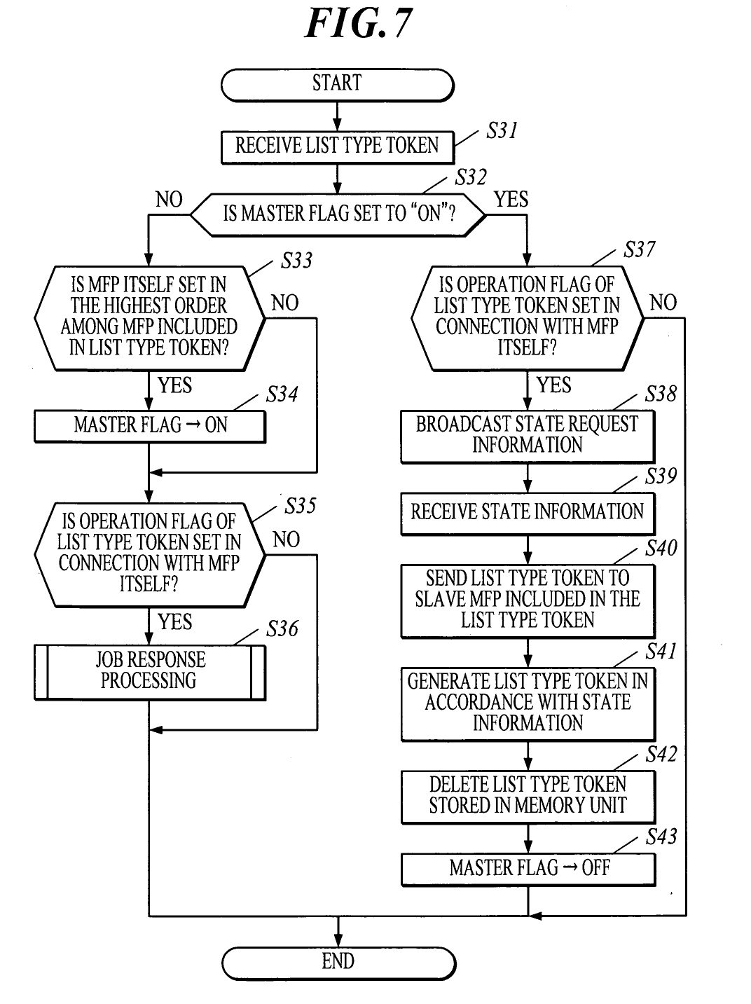

On the other hand, salve MFP that received the list type token (MFP 2B, MFP 2C, and MFP 2F) move on to list type token receiving processing described later (refer to FIG. 7). Here, among the slave MFP that received the list type token, MFP 2C that was set in the highest order in the list type token becomes the next master MFP.

Next, processing that relates to receiving list type token (hereinafter referred to as list type token receiving processing) is described with reference to FIG. 7. Each processing of FIG. 7 shows a processing executed by collaboration of the control unit 20 of the MFP 2, and the predetermined program stored in the memory unit 23.

First of all, when the control unit 2 receives a list type token (step S31), it determines whether MFP 2 itself has the master flag set to “ON” or not (step S32). In a case where it is determined that the master flag is set to “OFF” (step S32; No), it determines whether the order of MFP 2 itself is set in the highest order or not (step S33).

In a case where it is determined in step S33 that MFP 2 itself is set in the highest order (step S33; Yes), master flag that assigns MFP 2 itself as the master MFP is set to “ON” (step S34), and moves on to step S35. In a case where it is determined in step S33 that MFP 2 itself is not set in the highest order (step S33; No), it immediately moves on to step S35.

In the following step S35, the control unit 20 determines whether the operation flag of the list type token is recorded in connection with MFP 2 itself. In a case where it is determined that the operation flag is recorded in connection with MFP 2 itself (step S35; Yes), it moves on to job response processing (step S36) described later. In a case where it is determined in step S35 that the operation flag is recorded in connection with other MFP 2 (step S35; No), the present processing is concluded, and conducts standby until it receives the next list type token.

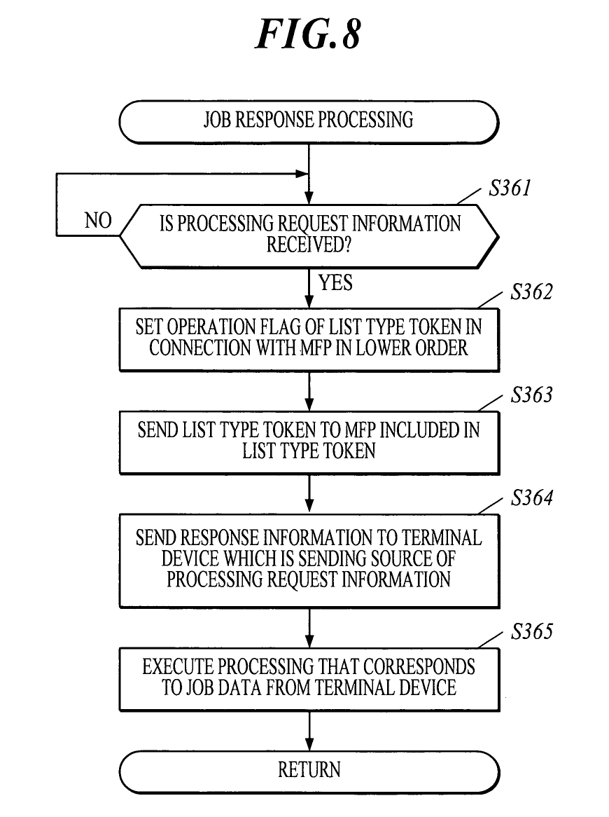

Hereinafter, job response processing of step S36 will be described with reference to FIG. 8.

First of all, the control unit 20 conducts standby until it receives processing request information that is broadcasted from the terminal device 1 (step S361; No). In a case where it is determined that the processing request information is received (step S361; Yes), the control unit 20 sets the operation flag of the list type token, that was set in connection with MFP 2 itself, in connection with MFP 2 that is in lower order (step S362), as an updated list type token. Subsequently, the updated list type token is distributed to other MFP 2 included in the list type token (step S363). Here, in step S362, after the operation flag is set in order until it raches the MFP 2 in the lowest order, the operation flag is once again returned to the MFP 2 in the highest order.

Next, the control unit 20 sends response information that informs that MFP 2 itself will conduct the print processing, to the terminal device 1 which is the sending source of the print job data (step S364). Subsequently, the control unit 20 executes print processing that corresponds to the job data by controlling the paper storing and feeding unit 25 and the image forming unit 26 (step S365), concludes the present processing and the list type token receiving processing, and conducts standby until the next list type token is received.

As described above, since the MFP 2 that corresponds to the processing request is listed by the list type token beforehand, each MFP 2 that is included in the list type token can confirm in advance whether the device itself corresponds to the next processing request. Therefore, prompt operation can be conducted for the processing request.

Here, referring back to FIG. 7, in a case where it is determined in step S32 that the master flag is set to “ON” (step S32; Yes), the control unit 20 determines whether the operation flag of the list type token is recorded in connection with MFP 2 itself or not (step S37).

In a case where it is determined in step S37 that the operation flag is recorded in connection with MFP 2 itself (step S37; Yes), the control unit 20 executes steps S38 through S43, concludes the present processing, and conducts standby until the next list type token is received. Here, concerning each processing of step S38 through S43, explanation is omitted since they are the same as the steps S11 through S16 of the afore-mentioned list type token generation processing.

On the other hand, in a case where it is determined in step S37 that the operation flag is recorded in connection with other MFP 2 (step S37; No), the control unit 20 immediately concludes the present processing and conducts standby until the next list type token is received.

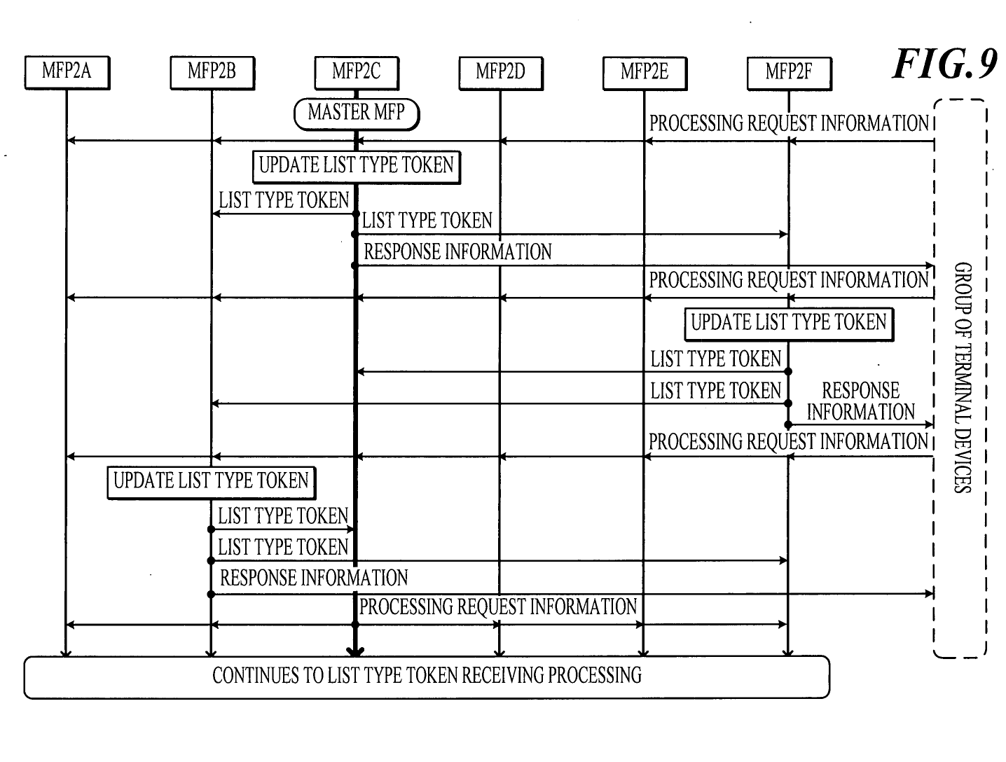

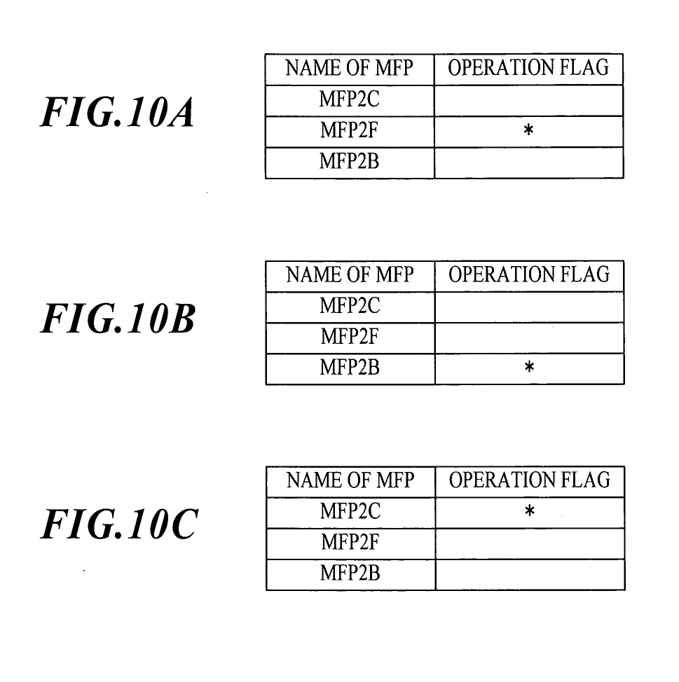

FIG. 9 and FIGS. 10A through 10C show performance of the MFP 2 when executing the afore-mentioned list type token receiving processing. Here, the list type token identified in the afore-mentioned FIG. 5 and FIG. 6 are continuously used for each MFP 2 shown in FIG. 9, and master flag of the MFP 2C is set to “ON”.

First of all, in a case where processing request information is broadcasted to each MFP 2 from either one of terminal device 1 among a plurality of terminal devices 1 that are connected to the print processing system 100, the MFP 2 which determined that the operation flag set in the list type token is set in connection with the MFP 2 itself (MFP 2C), among the MFP 2 that received the processing request information.

Then, the MFP 2C resets the operation flag of the list type token which is set in connection with MFP 2 itself to the MFP 2 that is in the lower order (MFP 2F) (refer to FIG. 10A), and distributes this updated list type token to other MFP 2 included in the list type token (MFP 2B and MFP 2F).

Subsequently, the MFP 2C sends response information that corresponds to the processing request information to the terminal device 1, which is the sending source of the processing request information, and then executes processing in accordance with the job data sent from the terminal device 1.

Next, in a case where processing request information is broadcasted to each MFP 2 from either one of terminal device 1 among a plurality of terminal devices 1 that are connected to the print processing system 100, the MFP 2 which determined that the operation flag set IN the list type token is set in connection with MFP 2 itself (MFP 2F), among the MFP 2 that received the processing request information.

Then, the MFP 2F resets the operation flag of the list type token L which is set in connection with MFP 2 itself to the MFP 2 that is in the lower order (MFP 2B) (refer to FIG. 10B), and distributes this updated list type token L to other MFP 2 included in the list type token (MFP 2B and MFP 2C).

Subsequently, the MFP 2F sends response information that corresponds to the processing request information to the terminal device 1, which is the sending source of the processing request information, and then executes processing in accordance with the job data sent from the terminal device 1.

Further, in a case where processing request information is broadcasted to each MFP 2 from either one of terminal device 1 among a plurality of terminal devices 1 that are connected to the print processing system 100, the MFP 2 which determined that the operation flag set in the list type token is set in connection with MFP 2 itself (MFP 2B), among the MFP 2 that received the processing request information.

Then, the MFP 2B resets the operation flag of the list type token L which is set in connection with MFP 2 itself to the MFP 2 that is in the lower order (MFP 2C) (refer to FIG. 10C), and distributes this updated list type token L to other MFP 2 included in the list type token (MFP 2C and MFP 2F).

Subsequently, the MFP 2B sends response information that corresponds to the processing request information to the terminal device 1 which is the sending source of the processing request information, and then executes processing in accordance with the job data sent from the terminal device 1.

As described, among the MFP 2 included in a list type token, operation flag is passed in order in accordance with the order of each MFP 2 that is set in the list type token. Accordingly, it can be assumed that a ring network (token ring) is virtually structured among each MFP 2. That is, only the MFP 2 that is set in connection with the operation flag at a particular time responds to the processing request from the terminal device 1.

On the other hand, concerning the MFP 2C which has master flag set to “ON”, in other words, concerning the master MFP, in a case where it receives a list type token as shown n FIG. 10C, step S37; Yes through step S43 of the afore-mentioned list type token response processing (refer to FIG. 7) are executed, and the state request information is broadcasted to each MFP 2 that is connected to the print processing system 100. That is, MFP 2C conducts the same performance as the performance of MFP 2A shown in FIG. 5.

As a result, since master MFP can be shifted for every predetermined timing, and since a newly generated list type token can be distributed, load that is borne on each MFP 2 can be distributed in accordance with the state of each MFP 2.

As described above, according to the present embodiment, since a list type token that identifies the order of MFP 2 that corresponds to processing request, that is in accordance with the state of each MFP 2, is distributed to each MFP 2, processing request can be managed in accordance with the order that is identified in the list type token. Therefore, even in a case where processing capacity is non-uniform among each MFP 2, load that is borne on each MFP 2 can be distributed in accordance with the state of each MFP 2. As a result, efficient operation can be conducted.

Here, in a case where the MFP 2, that is set with the operation flag, does not respond to the processing request information form the terminal device 1, for reasons such as occurrence of failure or the like, other MFP can detect such failure by determining whether the list type flag is received in a predetermined time from reception of the processing request information (hereinafter referred to as first predetermined time) or not. In such case, performance of the print processing system 100 can be maintained by having the master MFP, that detected the failure, set the operation flag to the MFP in lower order to update the list type token, and then distributing the updated list type token to each MFP 2 included in the list type token.

Further, in a case where the MFP 2, that is newly set with the operation flag, does not respond to the processing request information, the master MFP that detected the failure resets the operation flag to MFP in further lower order, and updates the list type token. Then the updated list type token is distributed to each MFP 2 included in the list type token. In a case where the operation flag is set in connection with the MFP in the lowest orders the afore-mentioned list type token generation processing (refer to FIG. 4) is executed. Here, the MFP 2 which determined that the operation flag set in the list type token is set in connection with the MFP itself, among the MFP 2 that received the new list type token, sends the response information that corresponds to the processing request information to the terminal device 1.

Concerning the afore-mentioned failure, in a case where the MFP does not respond, in a similar manner, other MFP 2 can detect such failure by determining whether the list type flag is received in a predetermined time from reception of the processing request information (hereinafter referred to as second predetermined time) or not. Here, it is preferable that the second predetermined time is longer than the first predetermined time. In such case, the MFP 2 that is in the next order from the highest order set in the list type token updates the list type token by eliminating the MFP 2 in the highest order, that is, the master MFP. Then, this updated list type token is distributed to each MFP 2 included in the list type token, and thus performance of the print processing system 100 can be maintained.

Here, the present invention is not limited to the afore-mentioned embodiment, and various kinds of modifications and alteration in design can be applied so long as it does not deviate the scope of the present invention.

For example, in the afore-mentioned embodiment, the MFP 2 that became the master MFP does not generate state information (state point). However, it is not limited to such embodiment, and the MFP 2 that became the master MFP may also generate state information, and generate list type token in accordance with the generated state information.

Further, in the afore-mentioned embodiment, a new list type token was generated in a timing in which the operation flag of the list type token makes a circle of the MFP 2 included in the list type token. However, it is not limited to such embodiment, and a new list type token may be generated in a timing, when time that is longer than a predetermined time is timed by the master MFP.

What is claimed is:

1. An information processing device comprising:
a communication unit to send first state information that identifies a state of the information processing device itself to at least one external information processing device, and to receive second state information that is sent from the at least one external information processing device; and
a control unit to generate first list information that identifies an order of information processing devices that corresponds to a processing request from an external device in accordance with the received second state information of the at least one external information processing device and the first state information of the information processing device itself, to send the first list information to the at least one external information device that is listed in the first list information through the communication unit, and to receive second list information that is sent from the at least one external information processing device through the communication unit;
wherein the control unit executes processing that corresponds to the processing request by a function unit owned by the information processing device itself, in accordance with the order of the information processing device itself that is set in the first list information or the second list information.

2. The information processing device of claim 1, wherein the control unit sets an operation flag that specifies a device that corresponds to the processing request, in connection with one information processing device that is listed in the first list information.

3. The information processing device of claim 2, wherein the control unit determines whether the operation flag that is set in the first list information or in the second list information is in connection with the information processing device itself, and manages the processing request as well as sends third list information with the operation flag set in connection with another information processing device(s) that is in a lower order than the information processing device itself, to the external information processing device(s) that is listed in the third list information through the communication unit, in a case where it is determined that the operation flag is set in connection with the information processing device itself.

4. The information processing device of claim 1, wherein the control unit determines whether the information processing device itself is set to the highest order in accordance with the received second list information, and in a case where it is determined that the information processing device itself is set to the highest order, sets a master flag, that shows whether the information processing device itself is a distribution source of any one of the first list information, the second list information, and the third list information, to master state.

5. The information processing device of claim 4, wherein the control unit sends state information request information that requests the second state information to the at least one external information processing device through the communication unit, in a case where it is determined that the information processing device itself is set to the highest order and the master flag is set to the master state.

6. The information processing device of claim 5, wherein the control unit sends the first state information of the information processing device itself to the at least one external information processing device through the communication unit, in a case where the control unit receives the state information request information through the communication unit.

7. The information processing device of claim 1, wherein the control unit generates the first state information in accordance with process capacity and/or process state of the information processing device itself.

8. The information processing device of claim 1, wherein the control unit determines whether to send or not to send the first state information to the at least one external information processing device, in accordance with the state of the information processing device itself.

9. An information processing system in which a plurality of information processing devices are connected so as to be able to communicate with each other, wherein each of the plurality of information processing devices comprises:
a communication unit to send first state information that identifies a state of the information processing device itself to the remaining one(s) of the information processing devices, and to receive second state information that is sent from the remaining one(s) of information processing devices; and
a control unit to generate first list information that identifies an order of information processing devices that corresponds to a processing request from external in accordance with the received second state information of the remaining one(s) of information processing devices and the first state information of the information processing device itself, to send the first list information to the remaining one(s) of information devices that is listed in the first list information through the communication unit, and to receive second list information that is sent from the remaining one(s) of information processing device through the communication unit;
wherein the control unit executes processing that corresponds to the processing request by a function unit owned by the information processing device itself, in accordance with the order of the information processing device itself that is set in the first list information or the second list information.

10. The information processing system of claim 9, wherein the control unit sets an operation flag that specifies a device that corresponds to the processing request, in connection with one information processing device that is listed in the first list information.

11. The information processing system of claim 10, wherein the control unit determines whether the operation flag that is set in the first list information or in the second list information is in connection with the information processing device itself, and manages the processing request as well as sends third list information with the operation flag set in connection with another information processing device that is in a lower order than the information processing device itself, to the remaining one(s) of information processing devices that is listed in the third list information through the communication unit, in a case where it is determined that the operation flag is set in connection with the information processing device itself.

12. The information processing system of claim 9, wherein the control unit determines whether the information processing device itself is set to the highest order in accordance with the second list information that is received, and in a case where it is determined that the information processing device itself is set to the highest order, sets a master flag, that shows whether the information processing device itself is a distribution source of any one of the first list information, the second list information, and the third list information, to master state.

13. The information processing system of claim 12, wherein the control unit sends state information request information that requests the second state information to the remaining one(s) of information processing devices through the communication unit, in a case where it is determined that the information processing device itself is set to the highest order and the master flag is set to the master state.

14. The information processing system of claim 13, wherein the control unit sends the first state information of the information processing device itself to the remaining one(s) of information processing devices through the communication unit, in a case where the control unit receives the state information request information through the communication unit.

15. The information processing system of claim 9, wherein the control unit generates the first state information in accordance with process capacity and/or process state of the information processing device itself.

16. The information processing system of claim 9, wherein the control unit determines whether to send or not to send the first state information to the remaining one(s) of information processing devices, in accordance with the state of the information processing device itself.

17. An information processing method of an information processing system in which a plurality of information processing devices are connected so as to be able to communicate with each other, comprising:
a communicating step in which one of the information processing devices sends first state information that identifies a state of the one of the information processing device itself to remaining one(s) of the information processing devices, and receives second state information that is sent from the remaining one(s) of the information processing devices;
a controlling step in which the one of the information processing devices generates first list information that identifies an order of information processing device that corresponds to a processing request from an external device in accordance with the received second state information of the remaining one(s) of the information processing devices and the first state information of the information processing device itself, sends the first list information to the remaining one(s) of the information devices that is listed in the first list information, and receives second list information that is sent from the remaining one of the information processing devices; and
a job responding step in which the one of the information processing device executes processing that corresponds to the processing request by a function unit owned by the information processing device itself, in accordance with the order of the information processing device itself that is set in the first list information or the second list information.

18. The information processing method of claim 17, wherein at the controlling step, an operation flag that specifies a device that corresponds to the processing request, is set in connection with one information processing device that is listed in the first list information.

19. The information processing method of claim 18, wherein at the controlling step, it is determined whether the operation flag that is set in the first list information or in the second list information is in connection with the information processing device itself, and the processing request is managed as well as third list information with the operation flag set in connection with another information processing device that is in a lower order than the information processing device itself is sent to the remaining one(s) of the information processing device that is listed in the third list information through the communication unit, in a case where it is determined that the operation flag is set in connection with the information processing device itself.

20. The information processing method of claim 17, wherein at the controlling step, it is determined whether the information processing device itself is set to the highest order in accordance with the received second list information, and in a case where it is determined that the information processing device itself is set to the highest order, a master flag, that shows whether the information processing device itself is a distribution source of any one of the first list information, the second list information, and the third list information, is set to master state.

21. The information processing method of claim 20, wherein at the controlling step, state information request information that requests the second state information is sent to the remaining one(s) of the information processing device, in a case where it is determined that the information processing device itself is set to the highest order and the master flag is set to the master state.

22. The information processing method of claim 21, wherein at the controlling step, the first state information of the information processing device itself is sent to the remaining one(s) of the information processing devices, in a case where the state information request information is received.

23. The information processing method of claim 17, wherein at the controlling step, the first state information is generated in accordance with process capacity and/or process state of the information processing device itself.

24. The information processing method of claim 17, wherein at the controlling step, it is determined whether to send or not to send the first state information to the external information processing device, in accordance with the state of the information processing device itself.
